(19) United States
(12) Patent Application Publication
(10) Pub. No.: US 2025/0347322 A1
(43) Pub. Date: Nov. 13, 2025

(54) SEALING DEVICE FOR WHEEL BEARING

(71) Applicants: STM CORPORATION, Daegu (KR); ILJIN Global Co., Ltd., Seoul (KR)

(72) Inventors: Se Hoon KIM, Changwon-si (KR); Su Won CHO, Daegu (KR); Gil Ho BAEK, Sangju-si (KR); Yong Won KIM, Anyang-si (KR); Seong Kyu JIN, Jinju-si (KR)

(73) Assignees: STM CORPORATION, Daegu (KR); ILJIN Global Co., Ltd., Seoul (KR)

(21) Appl. No.: 19/192,399

(22) Filed: Apr. 29, 2025

(30) Foreign Application Priority Data
May 7, 2024 (KR) 10-2024-0059998

(51) Int. Cl. F16C 33/78

(52) U.S. Cl. CPC F16C 33/7823; F16C 2326/02

(57) ABSTRACT

The present invention relates to a sealing device for a wheel bearing, including a hub part that is rotatable, a rotating disk part that is mounted on the hub part and of which an outer side temporarily stores moisture, a fixing disk part disposed to face the rotating disk part and coupled to an outer ring part, and a fixing sealing part formed in the fixing disk part, wherein a moisture movement direction toward a space between the rotating disk part and the fixing sealing part is changed several times.

### CROSS-REFERENCE TO RELATED APPLICATION

This application claims priority from and the benefit under 35 USC § 119 of Korean Patent Application No. 10-2024-0059998, filed on May 7, 2024, in the Korean Intellectual Property Office, the entire disclosure of which is incorporated by reference for all purposes.

### BACKGROUND

### 1. Field

The present invention relates to a sealing device for a wheel bearing, and more particularly, to a sealing device for a wheel bearing capable of suppressing inflow of moisture, trapping and discharging the moisture, and preventing a backflow of the moisture.

### 2. Description of the Related Art

Generally, a vehicle wheel bearing is a device for rotatably installing a wheel on a vehicle body, and the wheel bearing supports the wheel after a rotating element on which the wheel is mounted is connected to a non-rotating element fixed to the vehicle body through a rolling body and the wheel mounted on the rotating element is rotatably mounted on the vehicle body.

A wheel bearing according to the related art includes an outer ring fixed to the vehicle body, an inner ring installed inside the outer ring to be rotatable with respect to the wheel, and a rolling body (e.g., a ball or the like) interposed between the outer ring and the inner ring.

Since this wheel bearing is exposed to foreign substances such as dust and moisture from the outside due to characteristics of being mounted on the wheels of the vehicle, there is concern of shortening a lifetime due to damage to rotating surfaces of a wheel hub, the outer ring, or the like when foreign substances are introduced into the wheel bearing, and there is a risk of noise and vibration caused by the foreign substances during operation.

To solve this problem, a sealing member for preventing the inflow of foreign substances from the outside and preventing leakage of a lubricant (e.g., grease) is installed in the wheel bearing.

However, the sealing member has a problem in that inflow of moisture from the outside is not completely prevented, and foreign substances flow in reverse and are introduced. Therefore, it is required to solve this problem.

The related document related to the present invention is Korean Patent Publication No. 10-2018-0020823 (Feb. 28, 2018), and a wheel bearing assembly is disclosed in the related document.

### SUMMARY OF THE INVENTION

The present invention is directed to providing a sealing device for a wheel bearing capable of suppressing inflow of moisture, trapping and discharging the moisture, and preventing a backflow of the moisture.

A sealing device for a wheel bearing includes a hub part that is rotatable, a rotating disk part that is mounted on the hub part and of which an outer side temporarily stores moisture, a fixing disk part disposed to face the rotating disk part and coupled to an outer ring part, and a fixing sealing part formed in the fixing disk part, wherein a moisture movement direction toward a space between the rotating disk part and the fixing sealing part is changed several times.

The rotating disk part may include a rotating coupling portion coupled to the hub part, a rotating protrusion portion extending in a direction in which an outer diameter of the rotating coupling portion increases, a rotating space portion protruding from the rotating protrusion portion toward the fixing disk part and forming a space for preventing a backflow of moisture, and a rotating inflow portion that extends in a direction in which an outer diameter of the rotating space portion increases and suppresses inflow of foreign substances.

The rotating space portion may include a first space portion extending from the rotating protrusion portion toward the fixing disk part, a second space portion extending in a direction in which an outer diameter of the first space portion increases, and a third space portion extending from the second space portion in a direction away from the fixing disk part and disposed to face the first space portion.

The rotating disk part may further include a rotating scattering portion that is formed in one or more of the rotating space portion and the rotating inflow portion and induces scattering of foreign substances.

The fixing disk part may include a first fixing portion coupled to the outer ring part, disposed to face the third space portion, and spaced apart from the rotating inflow portion, a second fixing portion extending from the first fixing portion and disposed to face the second space portion, a third fixing portion extending obliquely from the second fixing portion toward the rotating protrusion portion, and a fourth fixing portion extending from the third fixing portion toward the rotating coupling portion.

The fixing sealing part may include a first sealing portion formed inside and outside the first fixing portion. a second sealing portion extending from the first sealing portion and formed inside the second fixing portion, a third sealing portion extending from the second sealing portion and formed inside the third fixing portion, a fourth sealing portion extending from the third sealing portion and formed inside and outside the fourth fixing portion, and a fifth sealing portion protruding from the fourth sealing portion toward the rotating disk part.

The fifth sealing portion may include a fifth sealing protrusion portion protruding obliquely from the fourth sealing portion up to a boundary point between the rotating protrusion portion and the rotating space portion and a fifth sealing contact portion extending from the fourth sealing portion and in close contact with the rotating protrusion portion.

### BRIEF DESCRIPTION OF THE DRAWINGS

The above matters and other objects, features and advantages of the present disclosure will become more apparent to those of ordinary skill in the art by describing exemplary embodiments thereof in detail with reference to the accompanying drawings, in which:

FIG. 1 is a schematic cross-sectional view illustrating a sealing device for a wheel bearing according to an embodiment of the present invention;

FIG. 2 is a schematic cross-sectional view illustrating a rotating disk part according to the embodiment of the present invention;

FIG. 3 is a schematic perspective view illustrating the rotating disk part according to the embodiment of the present invention;

FIG. 4 is a schematic view illustrating a fixing disk part and a fixing sealing part according to the embodiment of the present invention;

FIG. 5 is a schematic view illustrating a sealing device for a wheel bearing according to the related art in comparison to the present invention;

FIG. 6 is a schematic view illustrating a moisture inflow amount of the sealing device for the wheel bearing according to the embodiment of the present invention in comparison to the related art;

FIG. 7 is a schematic view illustrating sealing performance of the sealing device for the wheel bearing according to the embodiment of the present invention in comparison to the related art;

FIG. 8 is a schematic view illustrating a drag torque of the sealing device for the wheel bearing according to the embodiment of the present invention in comparison to the related art;

FIG. 9 is a schematic view illustrating a moisture inflow amount according to a length of a rotating inflow part according to the embodiment of the present invention;

FIG. 10 is a schematic view illustrating a moisture inflow amount and a moisture outflow amount according to a depth of a rotating space portion according to the embodiment of the present invention;

FIG. 11 is a schematic view illustrating a moisture inflow amount according to a width of the rotating space portion according to the embodiment of the present invention;

FIG. 12 is a schematic view illustrating a moisture inflow amount according to the presence or absence of a rotating scattering portion according to the embodiment of the present invention;

FIG. 13 is a schematic view illustrating a non-contact state between the rotating disk part and a bearing hub flange surface according to the embodiment of the present invention;

FIG. 14 is a schematic view illustrating a contact state between the rotating disk part and the bearing hub flange surface according to the embodiment of the present invention;

FIG. 15 is a schematic view illustrating an encoder that is mounted on a rotating protrusion portion according to the embodiment of the present invention; and

FIG. 16 is a schematic view illustrating the encoder that is mounted on the rotating protrusion portion and the rotating space portion according to the embodiment of the present invention.

### DETAILED DESCRIPTION

Hereinafter, a sealing device for a wheel bearing according to embodiments of the present invention will be described with reference to the accompanying drawings. In this process, the thicknesses of lines or the sizes of components illustrated in the drawings may be exaggerated for clarity and convenience of description. Further, terms described below are terms defined in consideration of functions in the present invention and may change according to the intention or custom of a user or an operator. Therefore, definitions of these terms should be made based on the contents throughout the specification.

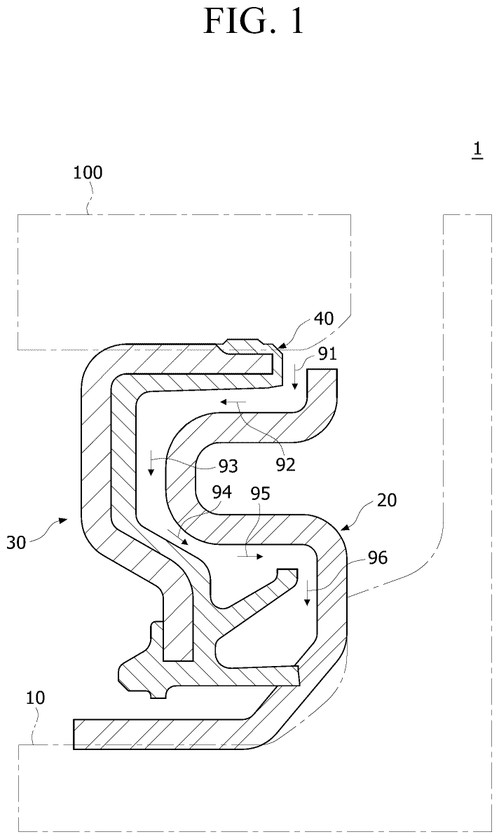

FIG. 1 is a schematic cross-sectional view illustrating a sealing device for a wheel bearing according to an embodiment of the present invention. Referring to FIG. 1, a sealing device 1 for a wheel bearing according to an embodiment of the present invention includes a hub part 10, a rotating disk part 20, a fixing disk part 30, and a fixing sealing part 40.

The hub part 10 may be rotated while connected to a wheel. The hub part 10 may correspond to an inner ring mechanically connected to a vehicle wheel and may have an annular shape having a hollow formed therein.

The rotating disk part 20 may be mounted on the hub part 10 and temporarily store moisture from the outside. As an example, the rotating disk part 20 may be partially coupled to the hub part 10 and interworked with the hub part 10. The rotating disk part 20 may be disposed to face the fixing disk part 30.

The fixing disk part 30 may be disposed to face the rotating disk part 20 and may be coupled to an outer ring part 100. As an example, the outer ring part 100 may be fixed to a vehicle body without rotating, may be installed while surrounding an outside of the hub part 10 with a bearing interposed therebetween, and may have an annular shape having a hollow to surround the outside of the hub part 10.

The fixing sealing part 40 may be formed in the fixing disk part 30. A space may be formed between the fixing sealing part 40 and the rotating disk part 20, and a moisture movement direction toward the space may be changed several times. As an example, a portion of the fixing sealing part 40 may be in close contact with the rotating disk part 20 to prevent inflow of foreign substances and moisture and absorb an external impact.

Meanwhile, the fixing sealing part 40 may be formed of rubber or a resin material having elasticity by molding and may be insert-molded integrally with the fixing disk part 30. That is, the fixing sealing part 40 including an elastic material may be formed on a surface of the fixing disk part 30 including a metal material. Therefore, since the fixing sealing part 40 is not in direct contact with the rotating disk part 20, an external impact can be absorbed.

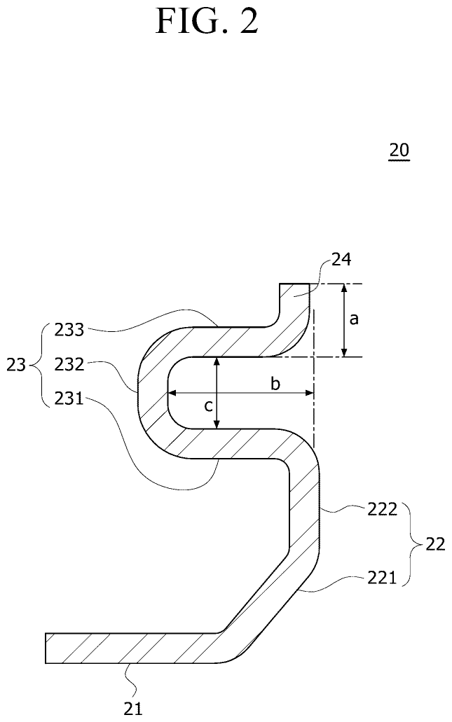

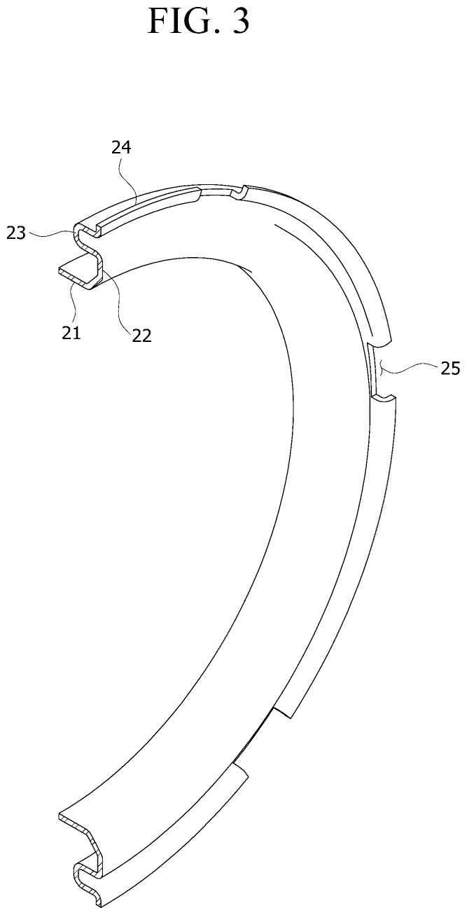

FIG. 2 is a schematic cross-sectional view illustrating a rotating disk part according to the embodiment of the present invention, and FIG. 3 is a schematic perspective view illustrating the rotating disk part according to the embodiment of the present invention. Referring to FIGS. 2 and 3, the rotating disk part 20 according to the embodiment of the present invention may include a rotating coupling portion 21, a rotating protrusion portion 22, a rotating space portion 23, and a rotating inflow portion 24.

The rotating coupling portion 21 may be coupled to the hub part 10. The rotating coupling portion 21 may have a cylindrical shape, and the hub part 10 may be in surface contact with an inner circumferential surface of the rotating coupling portion 21. The rotating coupling portion 21 may be maintained in a state of being coupled to the hub part 10 by a separate fixing means.

The rotating protrusion portion 22 may extend in a direction in which an outer diameter of the rotating coupling portion 21 increases. The rotating protrusion portion 22 may be bent and extend from one end of the rotating coupling portion 21. The rotating protrusion portion 22 may include a rotating inclined portion 221 extending from the rotating coupling portion 21 in an inclined direction and a rotating vertical portion 222 extending from the rotating inclined portion 221 in a vertical direction.

The rotating space portion 23 may protrude from the rotating protrusion portion 22 toward the fixing disk part 30 to form a space for preventing a backflow of moisture. As an example, a cross section of the rotating space portion 23 may have a U shape so that the rotating space portion 23 is recessed toward the fixing disk part 30.

The rotating inflow portion 24 may extend in a direction in which an outer diameter of the rotating space portion 23 increases and may suppress inflow of foreign substances. For example, the rotating inflow portion 24 may be disposed to be collinear with the rotating vertical portion 222.

The rotating space portion 23 according to the embodiment of the present invention may include a first space portion 231, a second space portion 232, and a third space portion 233.

The first space portion 231 may extend from the rotating protrusion portion toward the fixing disk part 30. As an example, the first space portion 231 may be vertically bent at an end of the rotating vertical portion 222 and extend toward the fixing disk part 30.

The second space portion 232 may extend in a direction in which an outer diameter of the first space portion 231 increases. As an example, the second space portion 232 may be bent vertically at an end portion of the first space portion 231 to extend.

The third space portion 233 may extend from the second space portion 232 in a direction away from the fixing disk part 30 and may be disposed to face the first space portion 231. For example, the third space portion 233 may have the same length as the first space portion 231 and may be vertically bent at an end portion of the second space portion 232 to extend.

A depth b of the rotating space portion 23 corresponding to the length of the first space portion 231 and the third space portion 233 may be in a range of 1 mm to 5 mm. A width c of the rotating space portion 23 corresponding to a length between the first space portion 231 and the third space portion 233 may be greater than or equal to 0.5 mm.

The rotating disk part 20 according to the embodiment of the present invention may further include a rotating scattering portion 25. The rotating scattering portion 25 may be formed in at least one of the rotating space portion 23 and the rotating inflow portion 24 to induce scattering of foreign substances. As an example, the rotating scattering portion 25 may form one or more grooves or holes in a circumferential direction to scatter foreign substances as the rotating disk part 20 rotates. The rotating scattering portion 25 may be formed in the rotating inflow portion 24 or may be formed in the rotating inflow portion 24 and the rotating space portion 23. The rotating scattering portion 25 may have a hole shape processed in a direction from an edge of the rotating inflow portion 24 toward a center of the rotating disk part 20. The rotating scattering portion 25 may be formed from the edge of the rotating inflow portion 24 to the entirety or a portion of the third space portion 233. The rotating scattering portion 25 may be formed when the rotating disk part 20 is formed or may be formed by processing after the rotating disk part 20 is formed.

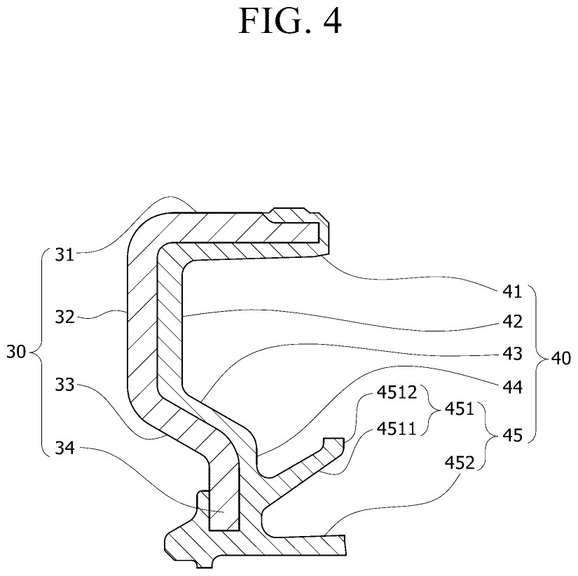

FIG. 4 is a schematic view illustrating a fixing disk part and a fixing sealing part according to the embodiment of the present invention. Referring to FIGS. 1 and 4, the fixing disk part 30 according to the embodiment of the present invention may include a first fixing portion 31, a second fixing portion 32, a third fixing portion 33, and a fourth fixing portion 34.

The first fixing portion 31 may be coupled to the outer ring part 100 and disposed to face the third space portion 233 and may be spaced apart from the rotating inflow portion 24. As an example, a first passage 91 for foreign substances may be formed in a space between an end portion of the first fixing portion 31 and an end portion of the rotating inflow portion 24. A second passage 92 for foreign substances may be formed in a space between the first fixing portion 31 and the third space portion 233. An inner diameter of the first fixing portion 31 may be formed to be shorter than an outer diameter of the rotating inflow portion 24.

The second fixing portion 32 may be disposed to extend from the first fixing portion 31 and face the second space portion 232. As an example, a third passage 93 for foreign substances may be formed in a space between the second fixing portion 32 and the second space portion 232.

The third fixing portion 33 may extend to be inclined in a direction from the second fixing portion 32 toward the rotating protrusion portion 22. As an example, the third fixing portion 33 may be disposed to face a boundary point between the first space portion 231 and the second space portion 232.

The fourth fixing portion 34 may extend from the third fixing portion 33 toward the rotating coupling portion 21. As an example, the fourth fixing portion 34 may be disposed between the rotating space portion 23 and the rotating coupling portion 21.

The fixing sealing part 40 according to the embodiment of the present invention may include a first sealing portion 41, a second sealing portion 42, a third sealing portion 43, a fourth sealing portion 44, and a fifth sealing portion 45.

The first sealing portion 41 may be formed inside and outside the first fixing portion 31. As an example, the first sealing portion 41 may be formed outside the first fixing portion 31 to prevent foreign substances from being introduced into a gap with the outer ring part 100. The first sealing portion 41 may be formed at an end portion and an inner side of the first fixing portion 31 to form the first passage 91 and the second passage 92.

The second sealing portion 42 may extend from the first sealing portion 41 and may be formed inside the second fixing portion 32. As an example, the second sealing portion 42 may face the rotating space portion 23 and form the third passage 93.

The third sealing portion 43 may extend from the second sealing portion 42 and may be formed inside the third fixing portion 33. The fourth sealing portion 44 may extend from the third sealing portion 43 and may be formed inside and outside the fourth fixing portion 34. A space between the third sealing portion 43 and the rotating space portion 23 may form a fourth passage 94.

The fifth sealing portion 45 may protrude from the fourth sealing portion 44 toward the rotating disk part 20. As an example, a plurality of fifth sealing portions 45 may protrude, but some thereof may be spaced apart from the rotating disk part 20, and the others thereof may be in close contact with the rotating disk part 20.

The fifth sealing portion 45 according to the embodiment of the present invention may include a fifth sealing protrusion portion 451 and a fifth sealing contact portion 452.

The fifth sealing protrusion portion 451 may protrude obliquely from the fourth sealing portion 44 up to a boundary point between the rotating protrusion portion 22 and the rotating space portion 23. As an example, the fifth sealing protrusion portion 451 may include a protrusion inclined portion 4511 protruding upwardly and a protrusion storage portion 4512 protruding upward from an end portion of the protrusion inclined portion 4511. Foreign substances may be temporarily stored in the fifth sealing protrusion portion 451. The fifth sealing protrusion portion 451 may be spaced apart from the rotating disk part 20. A space between the fifth sealing protrusion portion 451 and the rotating space portion 23 may form a fifth passage 95 for foreign substances passing through the fourth passage 94. A space between the fifth sealing protrusion portion 451 and the rotating protrusion portion 22 may form a sixth passage 96 for foreign substances passing through the fifth passage 95.

The fifth sealing contact portion 452 may extend from the fourth sealing portion 44 and be in close contact with the rotating protrusion portion 22. As an example, the fifth sealing contact portion 452 may restrict movement of foreign substances passing through the sixth passage 96. The fifth sealing contact portion 452 may be in close contact with the rotating inclined portion 221.

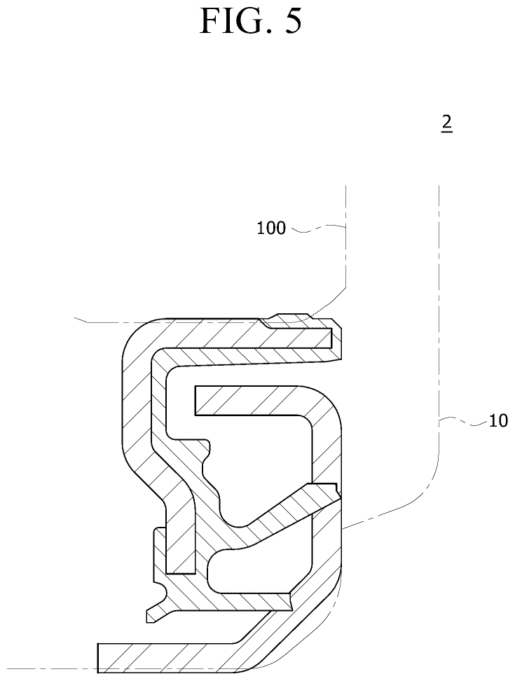

FIG. 5 is a schematic view illustrating a sealing device for a wheel bearing according to the related art in comparison to the present invention. Referring to FIG. 5, the sealing device 1 for the wheel bearing according to an embodiment of the present invention may be differentiated in that the rotating space portion 23 and the rotating inflow portion 24 are formed in comparison to a sealing device 2 for a wheel bearing according to the related art.

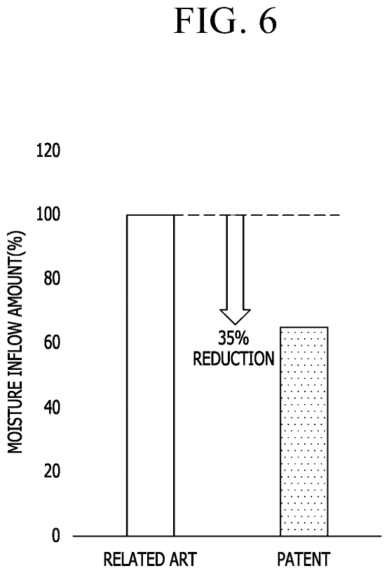

FIG. 6 is a schematic view illustrating a moisture inflow amount of the sealing device for the wheel bearing according to the embodiment of the present invention in comparison to the related art. Referring to FIG. 6, a moisture inflow amount of the sealing device 2 for the wheel bearing according to the related art is set to 100%. Meanwhile, it can be seen that the moisture inflow amount of the sealing device 1 for the wheel bearing in which the rotating space portion 23 and the rotating inflow portion 24 are formed according to the embodiment of the present invention is decreased by 35% in comparison to the related art.

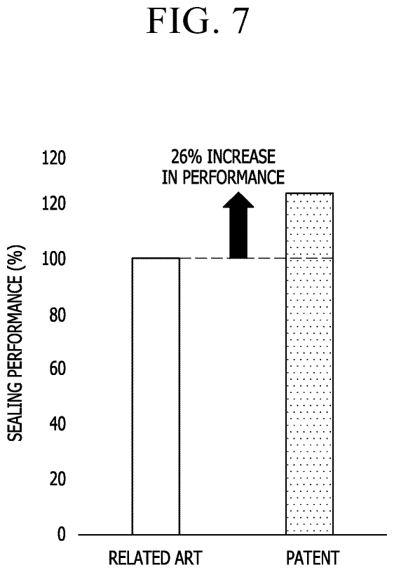

FIG. 7 is a schematic view illustrating sealing performance of the sealing device for the wheel bearing according to the embodiment of the present invention in comparison to the related art. Referring to FIG. 7, sealing performance of the sealing device 2 for the wheel bearing according to the related art is set to 100%. Meanwhile, it can be seen that the sealing performance of the sealing device 1 for the wheel bearing in which the rotating space portion 23 and the rotating inflow portion 24 are formed according to the embodiment of the present invention is increased by 26% in comparison to the related art.

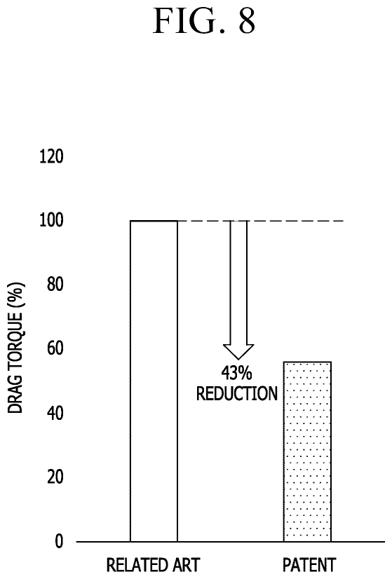

FIG. 8 is a schematic view illustrating a drag torque of the sealing device for the wheel bearing according to the embodiment of the present invention in comparison to the related art. Referring to FIG. 8, a drag torque of the sealing device 2 for the wheel bearing according to the related art is set to 100%. Meanwhile, it can be seen that the drag torque of the sealing device 1 for the wheel bearing in which the rotating space portion 23 and the rotating inflow portion 24 are formed according to the embodiment of the present invention is decreased by 43% in comparison to the related art.

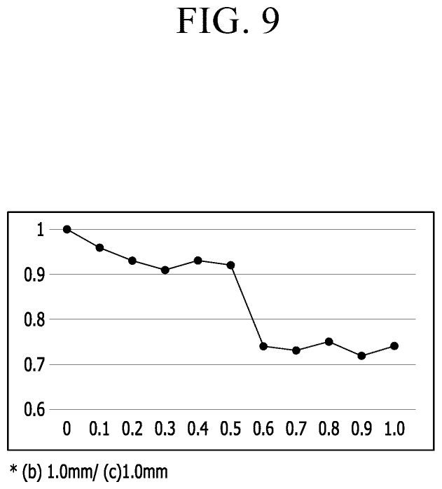

FIG. 9 is a schematic view illustrating a moisture inflow amount according to a length of a rotating inflow part according to the embodiment of the present invention. Referring to FIG. 9, it can be seen that the moisture inflow amount is greatly decreased in a section in which a length a of the rotating inflow portion 24 is greater than or equal to 0.6 mm.

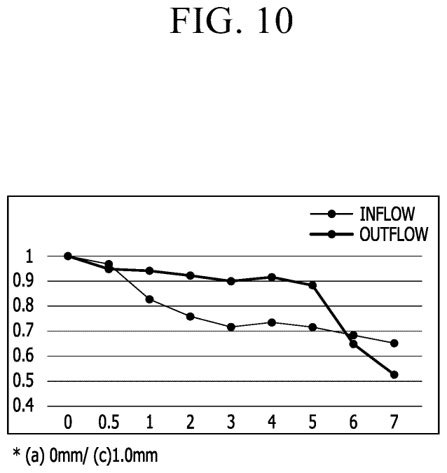

FIG. 10 is a schematic view illustrating a moisture inflow amount and a moisture outflow amount according to a depth of a rotating space portion according to the embodiment of the present invention. Referring to FIG. 10, the moisture inflow amount is significantly decreased in a section in which the depth b of the rotating space portion 23 is greater than or equal to 1 mm but discharge of introduced moisture is rapidly degraded from a section in which the depth b of the rotating space portion 23 is greater than or equal to 6 mm. Thus, the depth b of the rotating space portion 23 may be set to 1 mm to 6 mm.

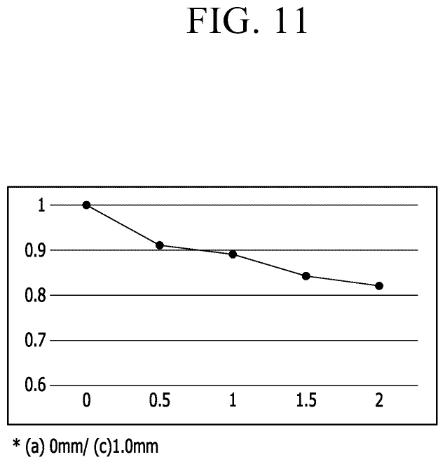

FIG. 11 is a schematic view illustrating a moisture inflow amount according to a width of the rotating space portion according to the embodiment of the present invention. Referring to FIG. 11, as the width c of the rotating space portion 23 is increased, the moisture inflow amount is decreased. However, it is necessary to secure the width of 0.5 mm or more in consideration of a product size.

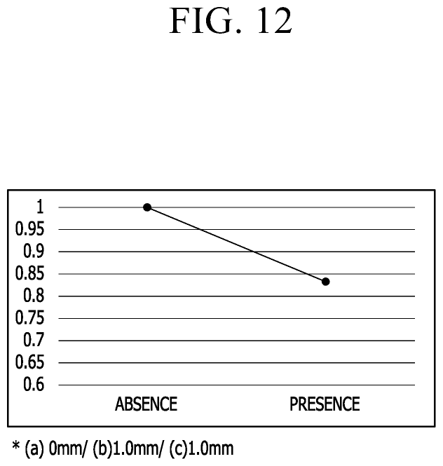

FIG. 12 is a schematic view illustrating a moisture inflow amount according to the presence or absence of a rotating scattering portion according to the embodiment of the present invention. Referring to FIG. 12, it can be seen that the moisture inflow amount is decreased by about 17% according to the presence or absence of the rotating scattering portion 25.

In the sealing device 1 for the wheel bearing according to the embodiment of the present invention, the rotating space portion 23 formed in the rotating disk part 20 forms a pocket for temporarily storing foreign substances, and the rotating inflow portion 24 formed in the rotating disk part 20 protrudes to face the fixing disk part 30 to suppress inflow of moisture.

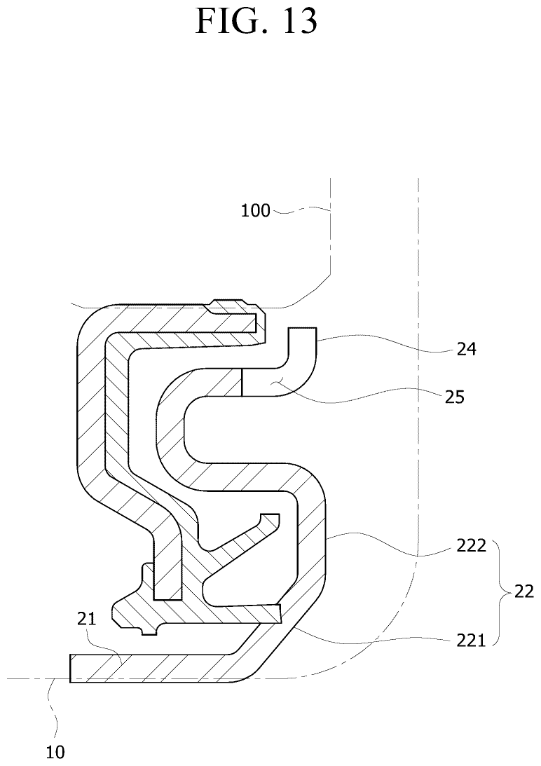

FIG. 13 is a schematic view illustrating a non-contact state between the rotating disk part and a bearing hub flange surface according to the embodiment of the present invention. Referring to FIG. 13, the hub part 10 may be coupled to the rotating coupling portion 21, and a flange surface of the hub part 10 may be spaced apart from the rotating protrusion portion 22.

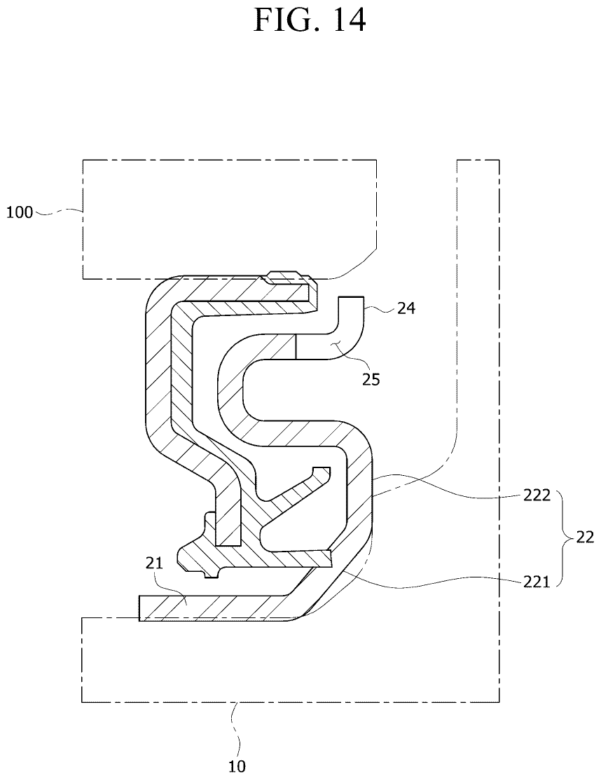

FIG. 14 is a schematic view illustrating a contact state between the rotating disk part and the bearing hub flange surface according to the embodiment of the present invention. Referring to FIG. 14, the hub part 10 may be coupled to the rotating coupling portion 21 and the rotating protrusion portion 22. The flange surface of the hub part 10 may be in contact with the rotating vertical portion 222.

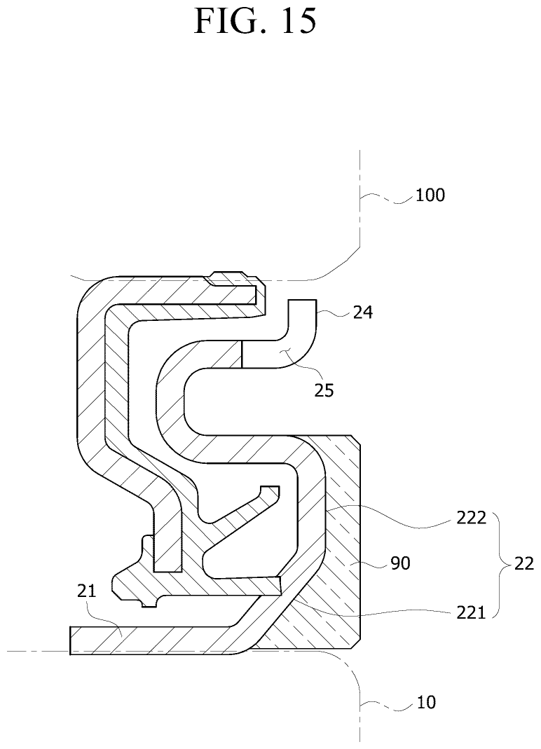

FIG. 15 is a schematic view illustrating an encoder that is mounted on a rotating protrusion portion according to the embodiment of the present invention. Referring to FIG. 15, an encoder 90 may be formed outside the rotating protrusion portion 22. In this case, the rotating disk part 20 may include the rotating scattering portion 25.

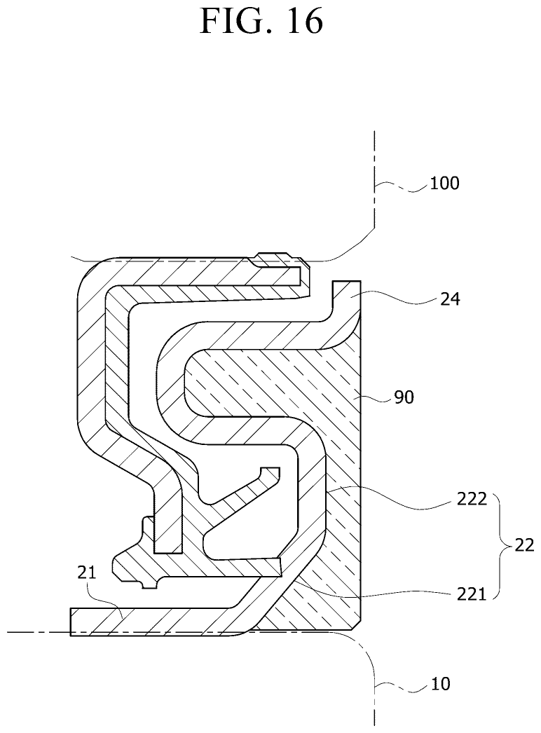

FIG. 16 is a schematic view illustrating the encoder that is mounted on the rotating protrusion portion and the rotating space portion according to the embodiment of the present invention. Referring to FIG. 16, the encoder 90 may be formed outside the rotating protrusion portion 22 and the rotating space portion 23. In this case, the rotating scattering portion 25 may be omitted from the rotating disk part 20.

According to a sealing device for a wheel bearing of the present invention, a pocket in which a rotating space portion formed in a rotating disk part temporarily stores foreign substances is formed, a rotating inflow portion formed in the rotating disk part protrudes to face a fixing disk part, and thus inflow of moisture can be suppressed.

Although the present invention has been described with reference to embodiments illustrated in the drawings, the description is merely illustrative, and those skilled in the art to which the technology belongs could understand that various modifications and other equivalent embodiments may be made. Thus, the true technical scope of the present invention should be determined by the appended claims.

What is claimed is:

1. A sealing device for a wheel bearing, comprising:
a hub part that is rotatable;
a rotating disk part that is mounted on the hub part and of which an outer side temporarily stores moisture;
a fixing disk part disposed to face the rotating disk part and coupled to an outer ring part; and
a fixing sealing part formed in the fixing disk part,
wherein a moisture movement direction toward a space between the rotating disk part and the fixing sealing part is changed several times.

2. The sealing device of claim 1, wherein the rotating disk part includes:
a rotating coupling portion coupled to the hub part;
a rotating protrusion portion extending in a direction in which an outer diameter of the rotating coupling portion increases;
a rotating space portion protruding from the rotating protrusion portion toward the fixing disk part and forming a space for preventing a backflow of moisture; and
a rotating inflow portion extending in a direction in which an outer diameter of the rotating space portion increases and configured to suppress inflow of foreign substances.

3. The sealing device of claim 2, wherein the rotating space portion includes:
a first space portion extending from the rotating protrusion portion toward the fixing disk part;
a second space portion extending in a direction in which an outer diameter of the first space portion increases; and
a third space portion extending from the second space portion in a direction away from the fixing disk part and disposed to face the first space portion.

4. The sealing device of claim 2, wherein the rotating disk part further includes a rotating scattering portion formed in one or more of the rotating space portion and the rotating inflow portion and configured to induce scattering of foreign substances.

5. The sealing device of claim 3, wherein the fixing disk part includes:
a first fixing portion coupled to the outer ring part, disposed to face the third space portion, and spaced apart from the rotating inflow portion;
a second fixing portion extending from the first fixing portion and disposed to face the second space portion;
a third fixing portion extending obliquely from the second fixing portion toward the rotating protrusion portion; and
a fourth fixing portion extending from the third fixing portion toward the rotating coupling portion.

6. The sealing device of claim 5, wherein the fixing sealing part includes:
a first sealing portion formed inside and outside the first fixing portion;
a second sealing portion extending from the first sealing portion and formed inside the second fixing portion;
a third sealing portion extending from the second sealing portion and formed inside the third fixing portion;
a fourth sealing portion extending from the third sealing portion and formed inside and outside the fourth fixing portion; and
a fifth sealing portion protruding from the fourth sealing portion toward the rotating disk part.

7. The sealing device of claim 6, wherein the fifth sealing portion includes:
a fifth sealing protrusion portion protruding obliquely from the fourth sealing portion up to a boundary point between the rotating protrusion portion and the rotating space portion; and
a fifth sealing contact portion extending from the fourth sealing portion and in close contact with the rotating protrusion portion.
